(19) United States
(12) Patent Application Publication
(10) Pub. No.: US 2024/0375065 A1
(43) Pub. Date: Nov. 14, 2024

(54) MOISTURE-GENERATING DEVICE FOR A FUEL CELL, AND METHOD FOR OPERATING A MOISTURE-GENERATING DEVICE

(71) Applicant: Robert Bosch GmbH, Stuttgart (DE)

(72) Inventors: Frank Miller, Ilsfeld (DE); Andreas Krause, Markgröningen (DE); Elmar Okrent, Remseck (DE)

(21) Appl. No.: 18/690,371

(22) PCT Filed: Aug. 11, 2022
(86) PCT No.: PCT/EP2022/072552

§ 371 Date: Mar. 8, 2024

(30) Foreign Application Priority Data
Sep. 9, 2021 (DE) 10 2021 209 971.8

(51) Int. Cl. B01F 25/314; B01F 23/213; B01F 25/452; B01F 35/90; B01F 35/93; B01F 101/55; B01F 101/59; H01M 8/04119

(52) U.S. Cl. CPC B01F 25/3141; B01F 23/2132; B01F 25/45211; B01F 35/93; H01M 8/04126; B01F 2035/99; B01F 2101/55; B01F 2101/59

(57) ABSTRACT

The present invention relates to a moisture-generating device (10) for generating a moisture-enriched air flow or gas flow, said device comprising: a housing (H) having a main extension direction (HR) and an inflow region (2) and an outflow region (3), and having a lateral inlet region (EB) which extends at a specified angle to the main extension direction (HR), and having a mixing region (MB), a water injector (WI) which is located in the lateral inlet region (EB) and by means of which atomized water can be introduced into the mixing region (MB) at the specified angle with or counter to the main extension direction (HR); a separator grid (SG) which is located in the mixing region (MB); and a homogenizing region (HB), which adjoins the mixing region (MB) in the main extension direction (HR), and wherein a degree of moisture of at least regions of the gas or air flow in the homogenizing region (HB) can be homogenized.

### BACKGROUND

The present invention relates to a moisture-generating device and a method for operating a moisture-generating device.

When using conventional fuel cell systems, a fuel gas can be supplied to the fuel cell, which may contain a certain degree of moisture. For example, in known fuel cell systems, if there is limited moisture, it may be necessary to increase it and to vary a degree of moisture in the fuel gas, in particular to increase it. This is performed by means of water atomization.

In this context, current systems may have a passive way of using water for fuel cell applications or for humidification. The aim can in this case be to reduce the size of such systems and to increase efficiency.

WO 2008/052578 A1 specifies a fuel cell system comprising an anode-side input for supplying a fuel.

### SUMMARY

The present invention relates to a moisture-generating device according to the disclosure and a method for operating a moisture-generating device according to the disclosure.

The idea behind the present invention is to specify a moisture-generating device and a method for operating a moisture-generating device, whereby moisture in an air flow or gas flow can be controlled and the effectiveness of the enrichment of the air or gas flow can be improved.

In this way, an active, more cost-effective, and robust means can be found to evaporate and distribute water better and more efficiently in the air flow or gas flow. In a system to which the air flow or gas flow can be delivered, e.g. a fuel cell, a dry air or gas flow, such as an air flow with low moisture, can be moistened with water vapor within a module placed upstream of the system (the housing of the moisture-generating device can be formed as a module). Advantageously, liquid water supplied from the outside within the module may be largely or completely evaporated and homogenized with the air flow or gas flow.

According to the present invention, the moisture-generating device for generating a moisture-enriched air or gas flow comprises a housing having a main extension direction and an inflow region and an outflow region, whereby a gas or air flow can be generated at least in regions along the main extension direction between the inflow region and the outflow region, and having a lateral inlet region which extends at a specified angle to the main extension direction, and having a mixing region, which extends inside the housing at least partially along the main extension direction; a water injector which is located in the lateral inlet region and by means of which atomized water can be introduced in the mixing region at the specified angle with or counter to the main extension direction, whereby, in the mixing region, the gas or air can be mixed with the atomized water; a separator grid which is located in the mixing region, and through which the gas flow or air flow mixed with the atomized water can flow, and a homogenizing region which adjoins the mixing region in the main extension direction and the separator grid is located between the mixing region and the homogenizing region, and whereby a degree of moisture of at least regions of the gas or air flow in the homogenizing region can be homogenized, whereby the outflow region closes off the homogenizing region in the main extension direction.

The gas or air flow can enter the housing, in particular the mixing region, at a particular rate through the entry region, which can comprise an inlet opening. After the exit region, which can comprise an outlet opening, the moisture-enriched gas or air flow can be delivered to, e.g., a fuel cell.

The designation “separator grid” can relate to a cylindrical wall, which can comprise a plurality of holes, which can be provided around the circumference of the cylindrical wall, approximately equidistant from one another. The size of the holes can be the same or vary. For example, the holes can be smaller towards the inlet region than towards the outlet region. The homogenizing region can be a portion of the housing, e.g. between the end region and the outlet region and, e.g., also partially overlapping with the end region. The degree of moisture can be balanced over a spatial distribution, i.e., “homogenized” when the gas flow or air flow passes through the homogenizing region.

The moisture-generating device can accordingly enrich an air flow or gas flow with evaporated or vaporized water.

The main extension direction can be parallel to the air flow or gas flow through the housing. The outflow region can comprise a round or otherwise shaped opening at one end of the housing in the main extension direction.

The lateral inlet region and the mixing region can be located in a front third of the housing, relative to the outflow region, which can be located at a rear end of the housing, and next to each other.

The outflow region and/or inlet region can be connected to another system, e.g. a fuel cell, which can require the air flow or gas flow.

The water injector can introduce water in the form of droplets, i.e. previously atomized water, into the mixing region and counter to the air or gas flow.

Compared to the known prior art, the moisture-generating device can be used to optimize both the water evaporation and the mixing of the water vapor with an air flow or gas flow being supplied to the fuel cell. A combination of numerous physical effects can be used to favor both evaporation and homogenization.

According to a preferred embodiment of the moisture-generating device, the mixing region is cylindrical and the separator grid is located in an end region of the mixing region and/or the mixing region comprises a cylindrical wall in the end region forming the separator grid, whereby the end region faces away from the inflow region in the main extension direction.

The separator grid can be separate to the housing and mixing region and can be mounted on or axially attached to the cylindrical wall of the mixing region. On the other hand, however, the separator grid can also be an end piece of the end region and integrally formed with the cylindrical mixing region. The arrangement of the separator grid and the mixing region in a cylindrical form can advantageously serve to allow the mixing region to be simply inserted into the housing or, if designed to be integral with the housing, to be simple and space-saving and/or advantageously also in a modular design, and can be compact in size and easily installed in a further system.

According to one preferred embodiment of the moisture-generating device, the homogenizing region surrounds the cylindrical wall at least partially radially and axially and extends in the main extension direction beyond the end region towards the outflow region.

After the gas or air flow passes through the holes, it can be radially delivered to the homogenizing region and follow it further around the end region and then back to the outlet region in the main extension direction. Recondensed water can be mixed with the gas or air again and evaporated by the passing flow.

According to a preferred embodiment of the moisture-generating device, the separator grid comprises an end plate or is located adjacent to the separator grid, which adjoins the cylindrical wall in the main extension direction and covers the mixing region towards the outlet region.

The end of the mixing region or end region can be axially closed by the end plate, whereby the gas flow or air flow is pressed radially outwards through the holes. Back pressure can also build up in the end region in front of the end plate, which may additionally drive the flow through the holes.

According to one preferred embodiment of the moisture-generating device, the cylindrical wall comprises a plurality of holes in the radial direction through which the air flow or gas flow can pass.

The air flow or gas flow can be advantageously pushed out of the mixing region through the holes, e.g. radially on all sides.

According to a preferred embodiment of the moisture-generating device, the water injector is a water atomizer by means of which water can be introduced into the mixing region in droplet form, whereby the size of the droplets can be varied.

The atomization of the water can advantageously be controlled by the water injector mentioned above, which is then also reflected in the effectiveness of evaporation.

According to a preferred embodiment of the moisture-generating device, it has a modular design.

The modular design makes it possible to achieve a compact component that can be easily integrated into other systems.

According to a preferred embodiment of the moisture-generating device, a cylindrical cross-section of the housing tapers in a region of the homogenizing region between the separator grid and the outflow region.

The taper can be used to vary a gradient of the velocity and pressure of the flow, which may then also affect mixing as well as a homogenization effect of the moisture.

According to one preferred embodiment of the moisture-generating device, the separator grid is heatable.

By heating the separator grid, i.e. the cylindrical wall, a degree of evaporation can be improved as the flow passes through the separator grid (through the holes and when the regenerated droplets detach at the holes).

Given a cylindrical shape, the housing can advantageously be easily installed in another system, such as in or upstream of a fuel cell system, and the gas flow or air flow can be passed through the housing more easily.

This moisture-generating device can be employed with or without a valve for metering water/water mixtures, e.g. in a gas valve.

As an alternative to a perforated cylinder, a non-metallic nonwoven fabric can also be used or, if additional heating is required, a metallic nonwoven fabric or metal foam (which can also be powered externally and thus heated).

According to the present invention, in a method for operating a moisture-generating device for generating moisture-enriched air flow or gas flow, a moisture-generating according to the present invention is provided; introducing the atomized water with the water injector into the mixing region at the specified angle with or counter to the main extension direction; wetting and/or penetrating the separator grid with the atomized water from the water injector; mixing the gas flow or air flow with the atomized water and delivering the gas flow or air flow to the outflow region.

The steps of wetting/penetration and mixing can also be carried out in parallel or in reverse order as mentioned.

According to one preferred embodiment of the method, a prespecified surface of the separator grid is wetted with atomized water and droplets reliquefied on the separator grid are evaporated and/or distributed on the separator grid by the gas flow or air flow, and the gas flow or air flow is homogenized with the water vapor and/or the droplets in the homogenizing region.

The larger the wetted region, the more evaporation can already take place on the separator grid.

According to one preferred embodiment of the method, the gas flow or air flow downstream of the flow generator and upstream of the outflow region through a homogenizing region and a gradient of moisture within the gas flow or air flow is homogenized at least in regions.

Homogenization can be advantageously increased, which can produce a more uniform gas flow or air flow in terms of moisture.

The moisture-generating device can also be characterized by the features specified in connection with the method and by the advantages of the method, and vice versa.

### BRIEF DESCRIPTION OF THE DRAWINGS

Further features and advantages of embodiments of the invention arise from the following description with reference to the accompanying drawings.

The present invention is explained in greater detail below with reference to the exemplary embodiments indicated in the schematic figures of the drawings.

Shown are:

FIG. 1 a schematic representation of a moisture-generating device according to an exemplary embodiment of the invention;

FIG. 2 a schematic representation of a moisture-generating device according to a further exemplary embodiment of the present invention;

FIG. 3 a block diagram of method steps of the method for operating a representation according to an exemplary embodiment of the present invention.

### DETAILED DESCRIPTION

In the drawings, identical reference signs denote identical or functionally identical elements.

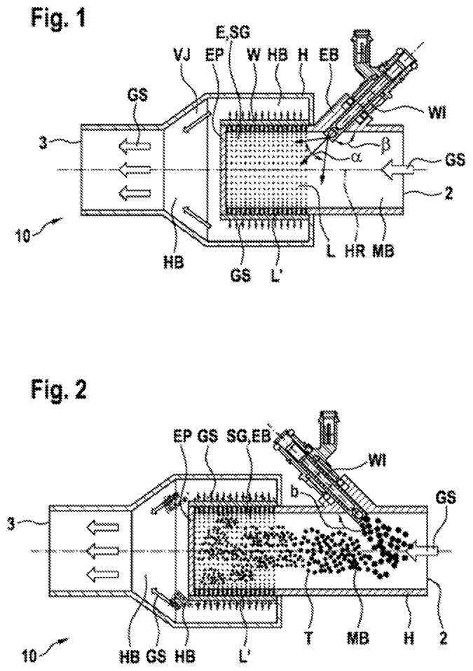

FIG. 1 shows a schematic representation of a moisture-generating device according to an exemplary embodiment of the invention.

The moisture-generating device 10 for generating a moisture-enriched air flow or gas flow, comprising a housing H having a main extension direction HR, approximately along an axis of symmetry when the housing H can be formed as cylindrical at least regions sections, and an inflow region 2, e.g. a circular opening of the cylindrical housing, and an outflow region 3, e.g. a circular opening of the cylindrical housing, whereby a gas or air flow is generated along the main extension direction HR at least in regions between the inflow region 2 and the outflow region 3, and having a side inlet region EB shaped as, e.g., a socket in the housing H, which region extends at a specified angle β to the main extension direction HR, and having a mixing region MB which extends inside the housing H at least partially along the main extension direction HR; a water injector WI which is located in the lateral inlet region EB and using which atomized water can be introduced at the specified angle β into the mixing region MB in the main extension direction HR, whereby in the mixing range MB, the gas or air can be mixed with the atomized water; a separator grid SG which is located in the mixing region MB and through which the gas or air flow mixed with the atomized water can flow, and a homogenizing region HB which adjoins the mixing region MB in the main extension direction HR, and the separator grid SG is located between the mixing region MB and the homogenizing region HB, and whereby a degree of moisture of the gas or air flow in the homogenizing region HB is at least in regions homogenizable, whereby the outflow region 3 closes the homogenizing region HB in the main extension direction.

The moisture-generating device 10 specified can in this case be designed such that the mixing region MB is cylindrical and the separator grid SG can be located in an end region E of the mixing region MB or the mixing region MB in the end region E comprises a cylindrical wall W, which forms the separator grid SG, whereby the end region E can face away from the inlet region 2 in the main extension direction HR.

Furthermore, the homogenizing region HB can at least partially surround the cylindrical wall W radially and axially, as seen from the axis of symmetry of the cylindrical wall and thus from the main extension direction HR, and extend in the main extension direction HR beyond the end region E towards the outflow region 3. The separator grid SG can comprise an end plate EP, which rests on the cylindrical wall W as a cover in the main extension direction HR and covers the mixing region MB towards the outflow region 3. The cylindrical wall W can comprise a plurality of holes L in the radial direction through which the air flow or gas flow can flow. The housing H can also comprise an inner region, which itself can be formed in regions as a cylindrical wall, and can surround the end region E with its cylindrical wall and the separator grid, whereby the end region E can be inserted into the inner region of the housing; this and the entire mixing region can be formed as a separate component (cylindrical). In this case, the end plate EP can be a part of the inner region or can be placed on the inner region in the axial direction towards the outflow region. Alternatively, the end region, the mixing region and the housing can, however, also be integrally formed.

The interior region can itself also comprise holes L′ in the radial direction, e.g. directly to adjacent to the holes L of the cylindrical wall W, although there can also be an intermediate distance between the wall W and the wall of the inner region.

Furthermore, the water injector WI can be a water atomizer, by means of which water in droplet form can be introduced into the mixing region MB, whereby the size of the droplets can be varied. A cylindrical cross-section of the housing H can taper as a VJ tape in a region of the homogenizing region HB between the separator grid SG and the outflow region 3.

In this case, the water injector WI can be a water atomizer, by means of which water in droplet form can be introduced into the mixing region MB, whereby the size of the droplets can be varied. These droplets can then wet the separator grid SG at least in regions, and the water injector can be set such that a wall of the mixing region opposite the lateral inlet opening EB is not wetted with water or the likelihood of this is at least reduced. This can be achieved by the velocity of the gas flow or air flow, when the injection rate of the water injector WI and the injection angle β and the opening angle α of the water injector (the cone under which the water can be injected) and the gas flow or air flow are optimized, such that the largest possible area of the separator grid SG is wetted when the water droplets are carried along with the gas flow or air flow GS, and the wall of the mixing region opposite the lateral inlet opening EB is not wetted with water or the likelihood of this is at least reduced.

After the gas or air flow has been mixed with the atomized water in the mixing region, the separator grid SG can be wetted with the water and/or the moist gas or the air flow GS can pass through the holes L and L′ and can also condense again at the holes, whereby a water film can form at the holes L, L′ and can then be detached again from the subsequent flow GS, e.g. as larger drops, after which evaporation can take place again up to the outflow region.

The taper VJ can be used to generate a gradient in the velocity of the gas flow or air flow GS in the direction of the outflow region 3. Such changes in width can produce a gradient (velocity and/or density) in the gas flow or air flow, thereby leading to a change (e.g., improvement) in the mixing and evaporation of the water.

The water injector WI attached to the side can atomize the liquid water supplied to it into droplets and inject it at a specified angle β into the mixing region MB or at least into a gas flow or air flow.

The water injector WI can be configured to generate a spray with the smallest droplets as possible and a sufficiently large angle α so that the spray can wet the largest possible regions of the separator grid SG. In this case, a pulse of the injected droplets can be so large that the spray can penetrate as large a cross-section of the mixing region MB as possible, but also so that the wall of the housing opposite the lateral inlet region EB is not wetted with a water film.

The water injector WI can comprise a swirl injector for this purpose, since it can generate a fine spray of medium pulses at a large angle α.

The water injector WI can therefore inject the water with the air flow or gas flow GS. On the way to the separator grid SG, the droplets can be exposed to an increased relative velocity to the flow GS, which can favor evaporation.

Large droplets then land on the perforated region of the separator cylinder and evaporate as a liquid film or are detached again on the other side as smaller droplets by the air passing through the grid (reatomization).

This process can be accelerated by additional electrical heating of the separator grid, but is only necessary if more new liquid is applied than can be evaporated or reatomized.

Small droplets can pass through the bores (holes) of the cylinder and then completely vaporize along with reatomized droplets in the region of the homogenizer HB. Due to the described measures, there is a high probability that a large part of the liquid has completely evaporated by the time it reaches the outlet region 3 of the water treatment module, or that the gas flow or air flow at least passes through it with only a small load of very small residual droplets.

FIG. 2 shows schematic representation of a moisture-generating device according to a further exemplary embodiment of the present invention.

In FIG. 2, a moisture-generating device 10 similar to FIG. 1 is shown, whereby the orientation of the water injector WI now runs counter to the current flow GS, at the injection angle b. The rate of injection and the volume of water injected can be selected and the injection cone of water then occurs at an opening angle α (not shown), whereby the latter can also be variable, and the water can be distributed into the flow GS, such that the separator grid SG is wetted as much as possible over the surface, but the wall of the mixing region MB opposite the inlet opening EB is not or only slightly wetted, at least with regard to a region of the opposite wall of the mixing region MB which does not, e.g., comprise any holes L.

The distance of the injector WI from the inlet of the separator cylinder (end region) can be so large that the angle b can be designed to be less than 90° and thus the spray can be injected against the air flow. This is then possible if the distance between injector WI and inlet 2 is sufficient to reverse the direction of flight of the droplets T before they wet solid walls in the mixing region MB.

On the way to the separator grid SG, the droplets are exposed to an increased relative velocity to the flow GS, which favors evaporation. In addition, the flight path and thus the flight duration of the droplets is increased until they reach the perforated area of the separator cylinder, which additionally supports evaporation.

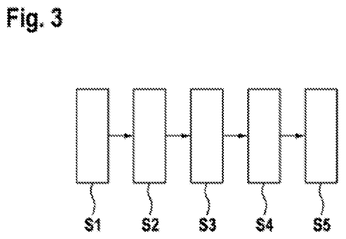

FIG. 3 shows block diagram of method steps of the method for operating a moisture-generating device according to an exemplary embodiment of the present invention.

In the method for operating a moisture-generating device for generating a moisture-enriched air flow or gas flow, the method comprises providing S1 a moisture-generating according to the present invention is provided; introducing S2 the atomized water with the water injector into the mixing region at the specified angle with or counter to the main extension direction; wetting S3 and/or penetrating the separator grid with the atomized water from the water injector; mixing S4 the gas flow or air flow with the atomized water and delivering S5 the gas flow or air flow to the outflow region.

Although the present invention has been completely described hereinabove with reference to the preferential exemplary embodiment, it is not limited thereto and can be modified in a variety of ways.

1. A moisture-generating device (10) for generating a moisture-enriched air flow or gas flow, said device comprising:
a housing (H) having a main extension direction (HR) and an inflow region (2) and an outflow region (3), wherein a gas or air flow is generated between the inlet region (2) and the outlet region (3) at least in regions along the main extension direction (HR), and having a lateral inlet region (EB) which extends at a specified angle to the main extension direction (HR), and having a mixing region (MB) which extends inside the housing (H) at least partially along the main extension direction (HR);
a water injector (WI) which is located in the lateral inlet region (EB) and by which atomized water can be introduced into the mixing region (MB) at the specified angle with or counter to the main extension direction (HR), wherein the gas or air can be mixed with the atomized water in the mixing region (MB);
a separator grid (SG) which is located in the mixing region (MB) and through which the gas or air flow mixed with the atomized water can flow, and
a homogenizing region (HB) which adjoins the mixing region (MB) in the main direction of extension (HR), and the separator grid (SG) is located between the mixing region (MB) and the homogenizing region (HB), and wherein a degree of moisture of the gas or air flow in the homogenizing region (HB) can be homogenized at least in certain regions, wherein the outflow region (3) closes off the homogenizing region (HB) in the main extension direction.

2. The moisture-generating device (10) according to claim 1, in which the mixing region (MB) is cylindrical, and the separator grid (SG) is located in an end region (E) of the mixing region (MB), and/or the mixing region (MB) in the end region (E) comprises a cylindrical wall (W) forming the separator grid (SG), wherein the end region (E) faces away from the inflow region (2) in the main extension direction (HR).

3. The moisture-generating device (10) according to claim 2, in which the homogenizing region (HB) surrounds the cylindrical wall (W) at least partially radially and axially and extends beyond the end region (E) towards the outflow region (3) in the main extension direction (HR).

4. The moisture-generating device (10) according to claim 2, in which the separator grid (SG) comprises an end plate (EP), or the end plate (EP) is located adjacent to the separator grid (SG), which adjoins the cylindrical wall (W) in the main extension direction (HR) and covers the mixing region (MB) towards the outlet region (3).

5. The moisture-generating device (10) according to claim 2, in which the cylindrical wall (W) comprises a plurality of holes (L) in the radial direction, through which the air or gas flow is able to flow.

6. The moisture-generating device (10) according to claim 1, in which the water injector (WI) is a water vaporizer, by which water in droplet form can be introduced into the mixing region (MB), wherein a size of the droplets can be varied.

7. The moisture-generating device (10) according to claim 1, which device has a modular design.

8. The moisture-generating device (10) according to claim 1, in which a cylindrical cross-section of the housing (H) tapers in a region of the homogenizing region (HB) between the separator grid (SG) and the outlet region (3).

9. The moisture-generating device (10) according to claim 1, in which the separator grid (SG) can be heated.

10. A method for operating a moisture-generating device (10) for generating a moisture-enriched air or gas flow, comprising the following steps:
providing (S1) a moisture-generating device (10) according to claim 1;
introducing (S2) atomized water by the water injector (WI) at the specified angle with or counter to the main extension direction (HR) into the mixing region (MB);
wetting (S3) and/or penetrating the separator grid (SG) with the atomized water from the water injector (WI);
mixing (S4) the gas flow or air flow with the atomized water and delivering (S5) the gas or air flow to the outflow region (3).

11. The method according to claim 10, in which a prespecified surface of the separator grid (SG) is wetted with atomized water and droplets reliquefied on the separator grid (SG) are evaporated and/or distributed on the separator grid (SG) by the gas or air flow, and the gas or air flow is homogenized with the water vapor and/or the droplets in the homogenizing region.
